(19) United States
(12) Patent Application Publication
(10) Pub. No.: US 2015/0178296 A1
(43) Pub. Date: Jun. 25, 2015

(54) INDEXING OF PART OF A DOCUMENT

(71) Applicant: NOKIA CORPORATION, Espoo (FI)

(72) Inventor: Yan FU, Espoo (FI)

(21) Appl. No.: 14/550,965

(22) Filed: Nov. 22, 2014

(30) Foreign Application Priority Data
Dec. 19, 2013 (GB) 1322518.0

(51) Int. Cl. G06F 17/30

(52) U.S. Cl. CPC G06F 17/3087

(57) ABSTRACT

An example embodiment comprising receiving of a document identified by a uniform resource locator, the document comprising document content, causing of display of a part of the document content, the part of the document content being less than the entirety of the document content, determining of an impression rating for the part of the document content based, at least in part, on the display of the part of the document, determining that the impression rating satisfies an impression rating threshold, and causing indexing, into a search index, of the part of the document content with regard to the uniform resource locator based, at least in part, on the determination that the impression rating satisfies the impression rating threshold is disclosed.

### RELATED APPLICATION

This application claims priority to Great Britain Application No. 1322518.0 filed Dec. 19, 2013, which is incorporated herein by reference in its entirety.

### TECHNICAL FIELD

The present application relates generally to document indexing and/or utilization of a search index.

### BACKGROUND

Electronic apparatuses have become a major part of the lives of their users. Many users rely on their electronic apparatuses for viewing various types of information. As users become more reliant upon their apparatuses for finding and viewing various types of information, users may experience difficulty in finding particular information when desired. It may be desirable to provide an electronic apparatus that is configured to provide a simple and intuitive manner for users to view information.

### SUMMARY

Various aspects of examples of the invention are set out in the claims.

One or more embodiments may provide an apparatus, a computer readable medium, a non-transitory computer readable medium, a computer program product, and a method for receiving of a document identified by a uniform resource locator, the document comprising document content, causing of display of a part of the document content, the part of the document content being less than the entirety of the document content, determining of an impression rating for the part of the document content based, at least in part, on the display of the part of the document, determining that the impression rating satisfies an impression rating threshold, and causing indexing, into a search index, of the part of the document content with regard to the uniform resource locator based, at least in part, on the determination that the impression rating satisfies the impression rating threshold.

One or more embodiments may provide an apparatus, a computer readable medium, a computer program product, and a non-transitory computer readable medium having means for receiving of a document identified by a uniform resource locator, the document comprising document content, means for causing of display of a part of the document content, the part of the document content being less than the entirety of the document content, means for determining of an impression rating for the part of the document content based, at least in part, on the display of the part of the document, means for determining that the impression rating satisfies an impression rating threshold, and means for causing indexing, into a search index, of the part of the document content with regard to the uniform resource locator based, at least in part, on the determination that the impression rating satisfies the impression rating threshold.

In at least one example embodiment, the document is a webpage.

In at least one example embodiment, the impression rating is a quantification of criteria that indicates significance of the part of the document content to a user in relation to the display of the part of the document content.

In at least one example embodiment, determination of the impression rating comprises identification of, at least one, impression indicative user interaction during display of the part of the document content.

In at least one example embodiment, the determination of the impression rating comprises determination of a display duration of the part of the document, wherein the determination of the impression rating for the part of the document content is based, at least in part, on the display duration.

In at least one example embodiment, determination that the impression rating satisfies the impression rating threshold comprises determination that the display duration satisfies a display duration threshold.

One or more example embodiments further perform receipt of information indicative of at least one document navigation input, wherein the determination of the impression rating comprises determination of an amount of navigation performed during display of the part of the document content, wherein the determination of the impression rating for the part of the document content is based, at least in part, on the amount of navigation.

In at least one example embodiment, determination that the impression rating satisfies the impression rating threshold comprises determination that the amount of navigation satisfies a navigation threshold.

In at least one example embodiment, the amount of navigation is based, at least in part, on measurement of at least one of number of document navigation inputs, frequency of document navigation inputs, frequency of display of the part of the document content caused by the document navigation input, or count of causation of display of the part of the document content caused by the document navigation input.

In at least one example embodiment, causation of display of the part of the document comprises causation of display of a first subpart of the document content, receipt of information indicative of a document navigation input, and causation of display of a second subpart of the document content based, at least in part, on the document navigation input, wherein the part of the document content comprises the first subpart of the document content and the second subpart of the document content.

In at least one example embodiment, the document navigation input is at least one of a scrolling input, a panning input, a page up input, a page down input, or an intra-document link selection input.

In at least one example embodiment, the first subpart of the document content is distinct from the second subpart of the document content.

In at least one example embodiment, the determination of the impression rating comprises determination of a prominence rating of the part of the document, wherein the determination of the impression rating for the part of the document content is based, at least in part, on the prominence rating.

In at least one example embodiment, determination that the impression rating satisfies the impression rating threshold comprises determination that the prominence rating satisfies a prominence rating threshold.

In at least one example embodiment, the prominence rating is a quantification that indicates a measure of visual emphasis of a part of the document content with respect to another part of the document content.

In at least one example embodiment, the other part of the document content is the entirety of the document content, such that prominence of the part of the document content identifies that the part of the document emphasizes the part of the document content beyond an average emphasis.

In at least one example embodiment, the measure of visual emphasis is based, at least in part, on at least one of font size, font color, proximity to an image, or type of document content.

In at least one example embodiment, type of document content identifies at least one of textual content, image content, audio content, or video content.

In at least one example embodiment, the determination of the impression rating comprises determination that the part of the document content has been displayed, wherein the determination of the impression rating for the part of the document content is based, at least in part, on the determination that the part of the document content has been displayed.

In at least one example embodiment, determination that the impression rating satisfies the impression rating threshold comprises determination that the part of the document content has been displayed.

In at least one example embodiment, the determination of the impression rating comprises determination of a user environment during display of the part of the document content, wherein the determination of the impression rating for the part of the document content is based, at least in part, on the user environment.

In at least one example embodiment, determination that the impression rating satisfies the impression rating threshold comprises determination that the determination that the user environment corresponds with at least one user environment exception.

In at least one example embodiment, the user environment indicates a time of day, the user environment exception is an operating time exception, and the determination that the user environment corresponds with at least one user environment exception comprises determination that the time of day deviates from a historical operational time region beyond a threshold time deviation.

In at least one example embodiment, the historical operation time region identifies a time period in which a user typically operates the apparatus.

In at least one example embodiment, the user environment indicates a time of day, the user environment exception is a calendar entry concurrence exception, and the determination that the user environment corresponds with at least one user environment exception comprises determination that the time of day occurs during a time of a calendar entry.

In at least one example embodiment, the user environment further indicates a location, and the determination that the user environment corresponds with at least one user environment exception comprises determination that the location corresponds with a location of the calendar entry.

In at least one example embodiment, the user environment indicates at least one proximate apparatus, the user environment exception is a proximate apparatus exception, and the determination that the user environment corresponds with at least one user environment exception comprises determination that the proximate apparatus is proximate to the apparatus.

In at least one example embodiment, the user environment indicates a weather condition, the user environment exception is an extreme weather exception, and the determination that the user environment corresponds with at least one user environment exception comprises determination that the weather condition is an extreme weather condition.

In at least one example embodiment, indexing of the part of the document content comprises correlating information indicative of the user environment with the uniform resource locator.

In at least one example embodiment, the indexing of the part of the document content is independent of indexing of metadata associated with the part of the document content.

In at least one example embodiment, the indexing of the part of the document content is independent of indexing of a title of the document.

In at least one example embodiment, the part of the document content omits a title of the document.

In at least one example embodiment, the indexing of the part of the document content omits indexing of document content that fails to correspond with the part of the document content.

In at least one example embodiment, the search index is stored in a repository comprised by the apparatus.

One or more example embodiments further perform receipt of information indicative of a document search query that comprises at least one search term, determination that at least one of the search terms correlates with at least one search index entry in the search index, and causation of display of information indicative of an indexed uniform resource locator associated with the search index entry.

In at least one example embodiment, determination that the search term correlates with the search index entry comprises determination that the search term matches the search index entry.

In at least one example embodiment, determination that the search term correlates with the search index entry comprises determination that the search term is relevant to the search index entry.

In at least one example embodiment, the determination of relevance is independent of the impression rating.

In at least one example embodiment, the information indicative of the indexed uniform resource locator comprises document content of a document identified by the indexed uniform resource locator.

One or more example embodiments further perform receipt of information indicative of selection of the indexed uniform resource locator, request of, at least a portion of, a document identified by the indexed uniform resource locator, receipt of the document identified by the indexed uniform resource locator, and causation of display of the document identified by the indexed uniform resource locator.

In at least one example embodiment, the search index entry comprises information indicative of a user environment, and further comprising causation of display of information indicative of the user environment in relation to the information indicative of the indexed uniform resource locator.

One or more example embodiments further perform causation of display of a different part of the document content, determination of a different impression rating for the different part of the document content based, at least in part, on the display of the different part of the document, determination that the different impression rating fails to satisfy the impression rating threshold, and preclusion of indexing, into the search index, of the different part of the document content with regard to the uniform resource locator based, at least in part, on the determination that the different impression rating fails to satisfy the impression rating threshold.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIG. 2 is a diagram illustrating apparatus communication according to at least one example embodiment;

FIGS. 3A-3C are diagrams illustrating document content according to at least one example embodiment;

FIG. 4 is a flow diagram illustrating activities associated with indexing of part of a document according to at least one example embodiment;

FIG. 5 is a flow diagram illustrating activities associated with indexing of part of a document according to at least one example embodiment;

FIG. 6 is a flow diagram illustrating activities associated with indexing of part of a document according to at least one example embodiment;

FIG. 7 is a flow diagram illustrating activities associated with indexing of part of a document according to at least one example embodiment;

FIG. 8 is a flow diagram illustrating activities associated with utilization of a search index according to at least one example embodiment; and

FIGS. 9A-9B are diagrams illustrating display of information indicative of the user environment in conjunction with information indicative of the uniform resource locator according to at least one example embodiment.

### DETAILED DESCRIPTION OF THE DRAWINGS

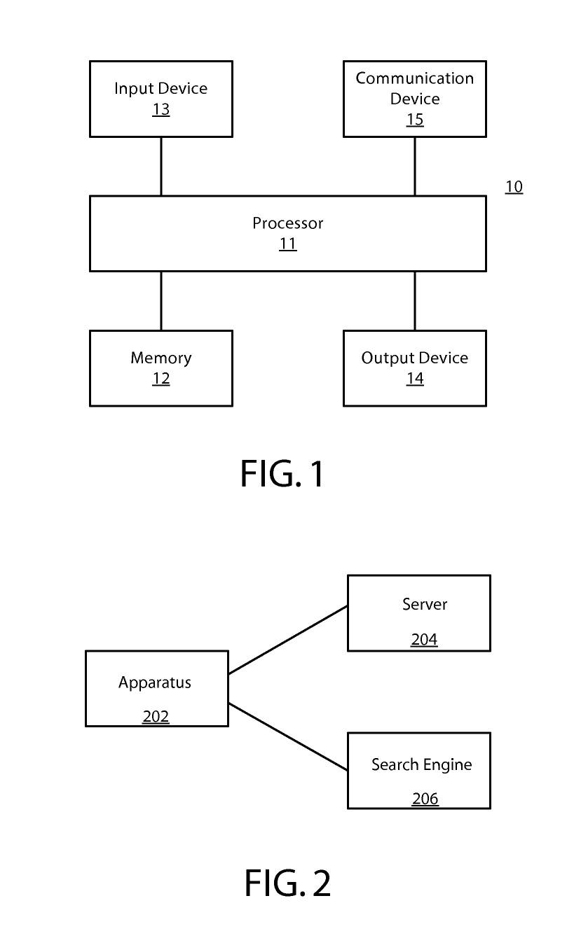

An embodiment of the invention and its potential advantages are understood by referring to FIGS. 1 through 9 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

FIG. 2 is a diagram illustrating apparatus communication according to at least one example embodiment. The example of FIG. 2 is merely an example and does not limit the scope of the claims. For example, number of apparatuses may vary, type of apparatuses may vary, communication paths may vary, and/or the like.

As electronic apparatuses have become more interconnected with other electronic apparatuses, many users have become accustomed to retrieving information from various separate apparatuses. For example, users may rely on retrieving information, such as documents, from an external server. For example, a user may desire to retrieve a webpage, a file, and/or the like. In such circumstances, the apparatus may be in communication with one or more separate apparatuses. The apparatus may utilize such communications to receive information from separate apparatuses.

The example of FIG. 2 illustrates apparatus 202 in communication with server 204 and search engine 206. It should be understood that, even though FIG. 2 illustrates a direct connection between apparatus 202 and server 204, and between apparatus 202 and search engine 206, there may be intermediate apparatuses that facilitate communication between apparatus 202 and server 204, and/or between apparatus 202 and search engine 206. For example, there may be one or more routers, hubs, switches, gateways, and/or the like, that are utilized in the communication channels between apparatus 202 and server 204, and/or between apparatus 202 and search engine 206. In addition, there may be other separate apparatuses that apparatus 202 is in communication with. For example, apparatus may be in communication with a different server, a domain name server, and/or the like.

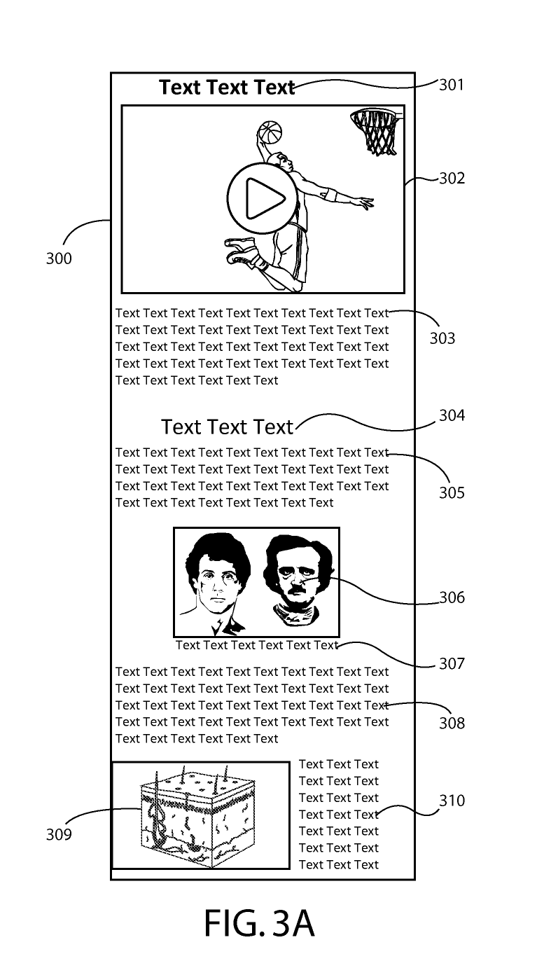

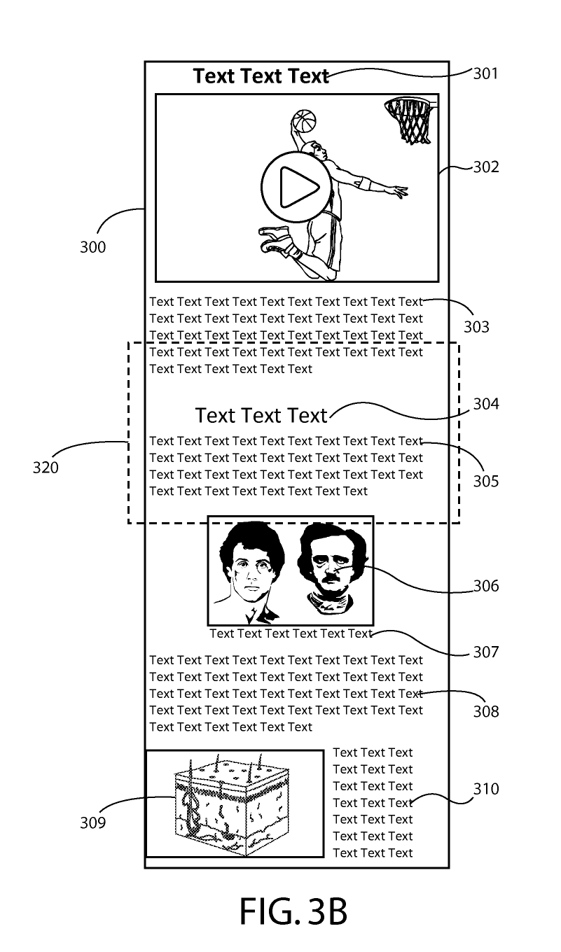

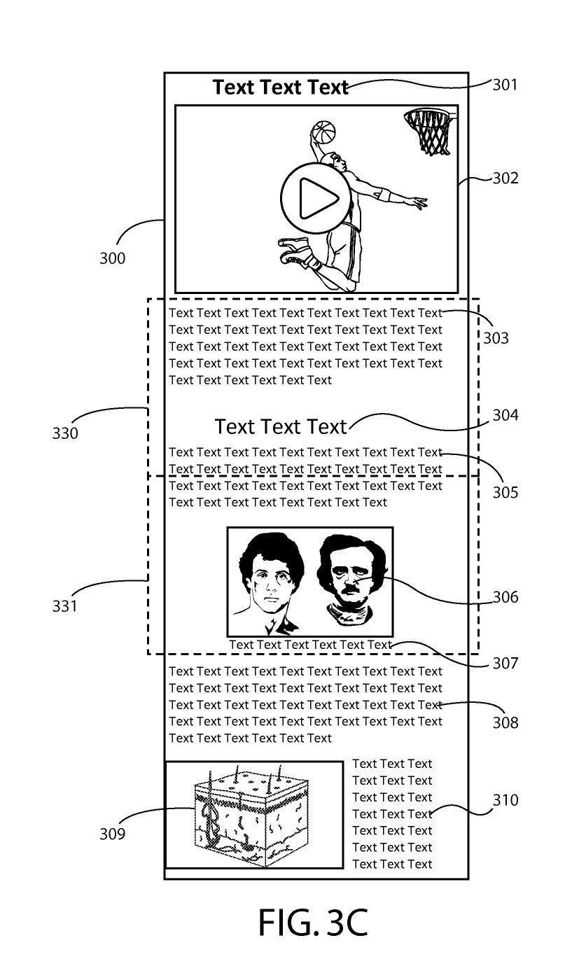

In some circumstances, it may be desirable to receive a document. For example, it may be desirable to receive a document identified by a uniform resource locator. In at least one example embodiment, an apparatus receives a document identified by a uniform resource locator. The document may be similar as described regarding FIGS. 3A-3C. In at least one example embodiment, the uniform resource locator is a character string that constitutes a reference to a resource. In at least one example embodiment, an apparatus may utilize a web browser program to receive information based, at least in part, on the uniform resource locator. For example, the uniform resource locator of a web page may be displayed inside an address bar. The apparatus may communicate with a domain name server to identify an address of a server that is associated with the uniform resource locator. For example, apparatus 202 may send a uniform resource locator to a domain name server, and receive an address that allows apparatus 202 to communicate with server 204. The apparatus may request one or more documents associated with the uniform resource locator. In at least one example embodiment, a document being associated with a uniform resource locator indicates that the uniform resource locator may be utilized to, at least partially, identify the document, the server from which the document may be retrieved, and/or the like. For example, a document may be referenced by the uniform resource locator such that the uniform resource locator unambiguously identifies the document. In this manner, the apparatus may request a document associated with a uniform resource locator from a server associated with the uniform resource locator. Such a request may be utilized to allow the apparatus to receive the document identified by the uniform resource locator.

In some circumstances, the apparatus and/or a user of the apparatus may be unaware of a uniform resource locator for information that the user desires. In such circumstances, it may be desirable for the apparatus to communicate with a separate apparatus that comprises a search engine. In at least one example embodiment, a search engine is a computer program that is designed to receive one or more queries that comprise one or more search terms, and return uniform resource locator information that may be related to one or more of the search terms. For example, the search engine may receive a query comprising search terms of “book shopping.” In such an example, the search engine may provide uniform resource locator information for servers that comprise documents that relate to shopping, that relate to books, and/or the like.

FIGS. 3A-3C are diagrams illustrating document content according to at least one example embodiment. The examples of FIGS. 3A-3C are merely examples and do not limit the scope of the claims. For example, content of the document may vary, format of the document may vary, and/or the like.

As previously described, an apparatus may receive a document identified by a uniform resource locator. The document may be any compilation of information. For example, the document may be a webpage, a file, a video, and/or the like. In at least one example embodiment, the document comprises document content. In at least one example embodiment, document content refers to a portion of the document that is configured to be presented to a user. For example, document content may be visual content, audible content, tactile content, and/or the like. Visual content may be textual content, image content, video content, and/or the like. For example, document content may comprise one or more images, text information, video information, audio information, and/or the like. In at least one example embodiment, the document content is distinct from document metadata. In at least one example embodiment, document metadata refers to information that is descriptive about the document itself. For example, the document metadata may classify document content, may describe, at least part of, the structure of the document, format of the document, and/or the like.

In at least one example embodiment, various portions of document content may be referred to as a part of a document, as a subpart of a document, and/or the like. A part of the document content may be the entirety of the document content, a part of the document content that is less than the entirety of the document content, and/or the like. For illustrative purposes, the term subpart indicates a portion of document content that is comprised by a part of the document content. This part and subpart terminology is merely used to indicate interrelationships between portions of document content and does not necessarily limit the claims in any way. A part of the document content may comprise a plurality of subparts. In some circumstances, one or more subparts of document content comprised by the part of the document content may be distinct from each other. For example, a part of the document content may comprise a first subpart of the document content and a second subpart of the document content. In such an example, the first subpart of the document content may be distinct from the second subpart of the document content. In such circumstances, the first subpart of the document content may fail to include any portion of the second subpart of the document content, the second subpart of the document content may fail to include any portion of the first subpart of the document content, and/or the like. In some circumstances, the first subpart of the document content may comprise overlapping subparts. In such circumstances, the first subpart of the document content may include a portion of the second subpart of the document content, the second subpart of the document content may include a portion of the first subpart of the document content, and/or the like.

FIG. 3A is a diagram illustrating document content according to at least one example embodiment. It can be seen that document content 300 comprises various type of document content. In at least one example embodiment, any of the denoted parts of document content, or any portion thereof, may be a part of the document content, a subpart of the document content, and/or the like. Document content 300 comprises textual content 301, video content 302, textual content 303, textual content 304, textual content 305, image content 306, textual content 307, textual content 308, image content 309, and textual content 310. It can be seen that textual content 301 has a larger font than textual content 303, textual content 305, textual content 307, textual content 308, and textual content 310. It can be seen that textual content 304 has a larger font than textual content 303, textual content 305, textual content 307, textual content 308, and textual content 310. It can further be seen that textual content 301 has a bolder font than textual content 303, textual content 304, textual content 305, textual content 307, textual content 308, and textual content 310. In the example of FIG. 3A, textual content 307 is proximate to image 306. In this manner, textual content 307 may be textual content associated with the image, such as a caption.

FIG. 3B is a diagram illustrating document content according to at least one example embodiment. In some circumstances, a document may comprise more content than may be displayed altogether on a display. In this manner, an apparatus may display a part of the document, but may fail to display another part of the document. In the example of FIG. 3B, part 320 of document content 300 indicates a part of document content 300 that is caused to be displayed. In the example of FIG. 3B, the part of document content 300 that is within the demarcation of part 320 indicates document content that has been caused to be displayed, and the part of document content beyond the demarcation of part 320 indicates document content that has failed to be displayed. In this manner, a user may have perceived part 320 of document content 300, but may have been precluded from perceiving document content outside of part 320 of document content 300, such as video content 302.

FIG. 3C is a diagram illustrating document content according to at least one example embodiment. In some circumstances, a user may desire to navigate through document content to view different parts of the document content. For example, the user may desire to scroll upward in the document content, scroll downward in the document content, scroll sideways in the document content, page upward in the document content, page downward in the document content, and/or the like. In some circumstances, it may be desirable for an apparatus to receive one or more document navigation inputs that allow a user to instruct the apparatus to perform navigation within the document content. In at least one example embodiment, the apparatus receives information indicative of at least one document navigation input. In at least one example embodiment, a document navigation input is an input that serves as a directive for the apparatus to perform navigation within the document content. The document navigation input may be a scrolling input, a panning input, a page up input, a page down input, an intra-document link selection input, and/or the like. It should be understood that there are many manners to navigate within a document and that there may be many manners to navigate within a document that are devised in the future. Therefore, the manner in which navigation is performed does not necessarily limit the claims in any way. The information indicative of the document navigation input may be keypad information, keypress information, gesture recognition information, motion information, and/or the like.

In at least one example embodiment, navigation within the document content comprises causation of display of a different part of the document content than previously displayed. For example, the apparatus may cause display of a part of document content prior to receipt of information indicative of a document navigation input. In such an example, the apparatus may cause display of a different part of the document content based, at least in part, on the document navigation input. For example, the apparatus may cause display of the different part of the document content in conformance with the document navigation input. For example, if the document navigation input is a scroll up input, the different part of the document content may be a part of the document content that is above the previously displayed document content.

As users have become more accustomed to receiving and viewing document content on their apparatuses, many users have become reliant on their apparatuses for viewing a large number of different documents on their apparatuses. In some circumstances, the user may desire to receive a document that he has already viewed on his apparatus. For example, the user may view a document, later view other documents, then even later, desire to view the document again. However, in some circumstances, the user may have difficulty remembering what the exact document is, how to find the document, a uniform resource locator associated with the document, how the user initially found the document, and/or the like. For example, the user may have initially viewed the document by way of sending a search query to a search engine. However, in such an example, the user may later have difficulty remembering the search terms that were used to cause the search engine to identify the uniform resource locator of the document. In another example, the search engine may have updated its search index such that, even if the user performed another search with the same search terms, the search engine may fail to identify the document again. For at least these reasons, it may be desirable to allow a user to receive a document that the user has previously viewed in an easy and intuitive manner.

It may be desirable to provide a manner for receiving a document that aligns with the manner in which humans process information. For example, many humans tend to remember information that they have perceived better than information that they have not perceived. For example, a person may more easily remember textual content that the person has read than general information that may pertain to the textual content. In this manner, the user may be more likely to remember textual content than metadata tags that indicate the subject matter of the textual content. In this manner, the textual content that the person has read has created an impression on the user, and the user is more likely to remember such information that created an impression in the mind of the user than general information that failed to create such an impression. For example, even though a subject matter indication for a document may be pertinent, a user may have difficulty recognizing the document based on such subject matter indication alone. However, in some circumstances, there may be document content within the document that the user may quickly recognize based, at least in part, on the impression that the document content made on the user. Therefore, it may be desirable to identify parts of document content that likely made an impression on the user, and to utilize such identified parts of the document content to facilitate later receipt of the document. For example, it may be desirable to utilize, at least part of, the identified document content to determine a uniform resource locator to utilize in retrieval of the document that comprises the document content.

In at least one example embodiment, an apparatus causes display of a part of document content, and determines an impression rating for the part of the document content. In at least one example embodiment, the impression rating is a value that may be utilized to ascertain the likelihood that a particular part of document content made an impression on the user, how likely the user is to remember perception of the document content, and/or the like. In at least one example embodiment, the impression rating is a quantification of criteria that indicates significance of the part of the document content to a user in relation to the display of the part of the document content.

In at least one example embodiment, the impression rating is based, at least in part, on the display of the part of the document. For example, an apparatus may determine a low or null impression rating for document content that failed to be displayed. In such an example, the low or null impression rating may be based, at least in part, on the unlikelihood of the user being able to remember document content that the user failed to view. In at least one example embodiment, the determination of the impression rating comprises determination that the part of the document content has been displayed. For example, the apparatus may assign a low or null impression rating to a part of document content based, at least in part, on a determination that the part of the document content failed to be displayed, was display for a negligible amount of time, and/or the like.

In at least one example embodiment, determination of the impression rating comprises identification of, at least one, impression indicative user interaction during display of the part of the document content. For example, there may be different types of interaction criteria that may indicate document content that the user is likely to remember. For example, there may be a particular quality of the document content that may be indicative of likelihood of the user remembering the document content, there may be circumstances involving the user's experience when viewing the document content that the user may likely remember, and/or the like. For example, the user may be likely to remember that he viewed the document content during a particular meeting, at an unusual time of day, during severe weather, and/or the like. In this manner, an anomalous environmental condition during viewing of a document may make the viewing of the document more memorable for the user. In another example, the user may interact with the apparatus in a manner that indicates attentiveness, such as performance of document navigation inputs, repeating viewing of a part of the document content, and/or the like. In still another example, there may be document content that has prominence over other document content such that the user may be likely to remember the prominent document content.

In at least one example embodiment, it may be desirable to index document content. For example, after the user has concluded interaction with a document, the user may desire to view the document again. In some circumstances, the apparatus may no longer contain the document in memory. In this manner, the user may desire to receive the document again to be able to interact with the document, view the document, and/or the like. In at least one example embodiment, the apparatus indexes a part of document content comprised by the document. In at least one example embodiment, the indexing of the part of the document content is independent of indexing of metadata associated with the part of the document content. For example, the apparatus may index document content separately from, exclusively to, and/or supplementally with metadata associated with the document. In at least one example embodiment, indexing of the document content fails to comprise indexing of the metadata. In at least one example embodiment, the indexing of the part of the document content is independent of indexing of a title of the document. For example, the apparatus may index document content separately from, exclusively to, and/or supplementally with a title of the document. In at least one example embodiment, indexing of the document content fails to comprise indexing of the title of the document. In at least one example embodiment, the part of the document content fails to comprise the title of the document. For example, the title of the document may be comprises by metadata, may be separable from the part of the document, and/or the like.

In at least one example embodiment, indexing of a document refers to updating and/or adding search index entries into a search index. In at least one example embodiment, a search index is a data structure, such as a database, that comprises one or more search index entries. In at least one example embodiment, a search index entry is a data structure that associates terms with uniform resource locators, with a part of a document, and/or the like. For example, an apparatus may perform a search by way of receiving one or more search terms, determining that at least one search term corresponds with one or more search index entries, and providing information associated with at least one document indicated by the search index entry. In this manner, the indexing of the document provides search index entries that may allow the apparatus to correlate one or more search terms with the document, with the uniform resource locator associated with the document, and/or the like. In at least one example embodiment, the apparatus causes indexing, into a search index, of a part of the document content with regard to an associated uniform resource locator. In at least one example embodiment, indexing of document content with regard to a uniform resource locator refers to indexing of document content in a manner that associates the uniform resource locator with one or more parts, and/or subparts, of the document content in the search index. In at least one example embodiment, the apparatus determines that at least one of the search terms correlates with at least one search index entry in the search index. In such an example, the apparatus may cause display of information indicative of an indexed uniform resource locator associated with the search index entry. In at least one example embodiment, information indicative of the indexed uniform resource locator associated with the search index entry may comprise a part of the document content, a subpart of the document content, an indication of the uniform resource locator, and/or the like.

In some circumstances, the user may favor utilization of a locally stored search index over utilization of an external search engine. For example, some external search engines provide advertising information as search results. The user may desire to avoid receiving, filtering, evaluating, and/or the like, advertising information embedded in the search results. In addition, some external search engines gather and/or store information regarding user identity and search terms. For example, such information may be utilized for targeted marketing, or other advertising efforts. In some circumstances, such information may be sold to third parties. Some users may desire to avoid providing information to such search engines, if possible. In addition, in some circumstances, utilization of an external search engine may involve greater resource utilization than utilization of a search index stored in memory. For example, the utilization of an external search engine may involve utilization of communication network resources, which may involve increased expense to the user, may consume more power than utilization of a search index stored in memory, and/or the like. In this manner, it may be desirable to utilize a search index stored in memory of the apparatus prior to utilization of the external search engine.

In at least one example embodiment, a search index is stored in a repository comprised by the apparatus. The repository may be a part of memory, such as a database, a file, and/or the like. In at least one example embodiment, the apparatus may access the repository absent communication with a separate apparatus, such as a search engine, a server, and/or the like.

In some circumstances, it may be desirable to index document content based, at least in part, on the impression rating associated with the document content. For example, many users evaluate documents multiple times. For example, a user may be researching a particular topic. In such an example, the user may view parts of many documents when performing such research. However, at a later time, the user may desire to view a document that the user has previously viewed, but fails to remember specific search terms that would allow the user to provide a search query for finding the document by way of a search engine. For example, the user may no longer remember the search terms that the user previously used when finding the document, the search engine may have changed its search index such that the same search terms may no longer be associated with the document, and/or the like. However, in such circumstances, there may be particular parts of the document content that the user may remember. For example the user may remember a part of the document content that made an impression on the user. In this manner, it may be desirable to base the indexing, at least in part, on the impression rating of a part of the document content.

In some circumstances, it may be desirable to avoid indexing of information that the user is unlikely to remember. For example, the user may desire to avoid viewing search results that are based on correlation of search index entries that fail to correspond with document content that made an impression on the user. For example, a user may have previously viewed a part of document content of a document, and failed to view a different part of the document content of the document. In such an example, the user may desire to avoid receiving search results that include the different part of the document. In such an example, the user may be searching based on his recollection of what he has read before. In such an example, the user may desire to avoid search results that may have failed to create an impression on the user, such as search results that pertain to an unread part of the document content, for, at least, the reason that the user is unlikely to remember the document content that the user failed to read. In another example, a part of the document that was merely displayed for an insubstantial amount of time may have failed to create an impression on the user. In such an example, the user may be unlikely to remember a part of the document that was displayed only during scrolling to another part of the document. It should be understood that there may be circumstances where the user desires to search based on impression rating and based on information that is independent of impression rating. In this manner, the search index that is indexed based, at least in part, on the impression rating may be used in conjunction with another search index. For example, the apparatus may correlate search results from a plurality of search indexes, which may include the search index that was based, at least in part, on the impression rating.

In at least one example embodiment, the causation of indexing of a part of document content is based, at least in part, on a determination that the impression rating associated with the part of the document content satisfies the impression rating threshold. In at least one example embodiment, an impression rating threshold is a value that the apparatus utilizes to identify an impression rating that is sufficient to cause indexing. For example, an impression rating threshold may be set such that document content that failed to be displayed fails to satisfy the impression rating threshold. In at least one example embodiment, the indexing of the part of the document content omits indexing of document content that fails to correspond with the part of the document content that satisfies the impression rating threshold. In at least one example embodiment, the apparatus precludes indexing of a part of the document content based, at least in part, on a determination that the impression rating associated with the part of the document content fails to satisfy the impression rating threshold.

It may be desirable to base the impression rating of a part of a document based on one or more aspects of the user's experience with the part of the document content. For example, the impression rating may be based, at least in part, on whether the part of the document content has been displayed, a duration in which the part of the document content was displayed, amount of navigation performed during display of the part of the document content, a prominence rating of the part of the document content, and/or the like. It should be understood that, even though the various bases for determination of impression rating are described individually, an impression rating may be based, at least in part, on a combination of such bases. For example, the impression rating may be based, at least in part, on whether the document content has been display and a prominence rating of the part of the document content.

In at least one example embodiment, the apparatus determines that a part of document content has been displayed. In such an example, the apparatus may determine the impression rating based, at least in part on, the determination that a part of document content has been displayed. In at least one example embodiment, determination that the impression rating satisfies the impression rating threshold comprises determination that the part of the document content has been displayed. For example, the impression rating threshold may be indicative of an impression rating that indicates that the part of the document was displayed.

In at least one example embodiment, the determination of the impression rating comprises determination of a display duration of the part of the document, wherein the determination of the impression rating for the part of the document content is based, at least in part, on the display duration. The display duration may be a time period for which the part of the document content was displayed. For example, the display duration may be a duration in which the document content was contiguously displayed. For example, the display duration of textual content 304 of FIG. 3B may a duration for which part 320 of document 300 was displayed. In another example, where there were document navigation inputs that caused navigation to and/or from display of the part of the document content, the display duration may be a summation of a plurality of time periods for which the part of the document content was displayed. For example, the display duration of image content 306 of FIG. 3C may be a summation of a plurality of time periods in which part 331 of document content 300, which includes image content 306, was displayed. For example, the apparatus may include time periods in which part 331 of document 300 was displayed, and fail to include time periods in which part 330 of document 300 were displayed. In at least one example embodiment, the determination that the impression rating satisfies the impression rating threshold comprises determination that the display duration satisfies a display duration threshold. For example, the display duration threshold may be indicative of an impression rating that indicates that the part of the document content was displayed for a time period that was sufficient to create an impression on the user, such as five minutes, ten minutes, and/or the like.

As previously described, the apparatus may receive information indicative of at least one document navigation input. In at least one example embodiment, the determination of the impression rating comprises determination of an amount of navigation performed during display of the part of the document content. In such an example, the determination of the impression rating for the part of the document content may be based, at least in part, on the amount of navigation. In at least one example embodiment, the amount of navigation is based, at least in part, on measurement of number of document navigation inputs, frequency of document navigation inputs, frequency of display of the part of the document content caused by the document navigation input, count of causation of display of the part of the document content caused by the document navigation input, and/or the like. For example, the amount of navigation performed during display of textual content 305 of FIG. 3C may be based, at least in part, on amount of document navigation inputs associated with transition of display between part 330 of FIG. 3C and part 331 of FIG. 3C. For example, the user may scroll up and down to repeatedly read textual content 305. In this manner, such scrolling may indicate that the user has paid particular attention to textual content 305. In some circumstances, such amount of navigation may indicate that textual content 305 has created an impression on the user. In at least one example embodiment, the determination that the impression rating satisfies the impression rating threshold comprises determination that the amount of navigation satisfies a navigation threshold. For example, the navigation threshold may be indicative of an impression rating that indicates that an amount of navigation was perform regarding display of the part of the document content that was sufficient to create an impression on the user.

In at least one example embodiment, the determination of the impression rating comprises determination of a prominence rating of the part of the document. In such an example, the determination of the impression rating for the part of the document content may be based, at least in part, on the prominence rating. In at least one example embodiment, the prominence rating is a quantification that indicates a measure of visual emphasis of a part of the document content with respect to another part of the document content. In at least one example embodiment, the measure of visual emphasis is based, at least in part, on font size, font color, proximity to an image, type of document content and/or the like. In at least one example embodiment, the type of document content identifies at least one of textual content, image content, audio content, or video content. For example, the apparatus may determine that image content has greater prominence than textual content, that video content has greater prominence than audio content, and/or the like. In another example, the apparatus may determine that a greater font size indicates a greater prominence than a lesser font size. For example, the apparatus may determine that the greater font size of textual content 304 indicates a greater prominence than the prominence of textual content 305. In another example, the apparatus may determine that textual content 301 has greater prominence than textual content 304 based, at least in part, on textual content being represented in a bold font and textual content 304 being represented in a non-bold font. In at least one example embodiment, the other part of the document content is the entirety of the document content. In such an example, the prominence of a part of the document content may identify that the part of the document emphasizes the part of the document content beyond an average emphasis. An average emphasis may identify an amount of emphasis for a mean measure of visual emphasis for the other part of the document content, such as a mean measure of visual emphasis of the entirety of the document.

In at least one example embodiment, prominence of a part of the document may be based, at least in part, on a relationship between the part of the document and another part of the document. For example, textual content that is proximate to image content may have a similar prominence rating as the image content. In such an example, the user may remember textual content that is spatially associated with an image similar to the manner in which the user remembers the image. For example the textual content may be a caption to the image content. In such an example, the user may remember the caption of the image content to a similar extent that the user remembers the image content. For example, it can be seen that textual content 307 is proximate to image content 306. In the example of FIGS. 3A-3C, textual content 307 is a caption to image content 306. In such an example, the apparatus may determine that image content 306 and textual content 307 have a greater prominence than textual content 308. Such determination may be based, at least in part, on proximity of textual content 307 to image content 306.

In at least one example embodiment, the determination that the impression rating satisfies the impression rating threshold comprises determination that the prominence rating satisfies a prominence rating threshold. For example, the prominence rating threshold may be indicative of an impression rating that indicates that the part of the document content was had sufficient prominence to create an impression on the user.

As previously described, it may be desirable to base the impression rating on aspects of the user's interaction with the document content that may be memorable to the user. In some situations, the circumstances in which the user is interacting with the content may be memorable to the user. For example, there may be something memorable about an aspect of the user environment while the user is interacting with the document content. For example, a user may be more likely to remember viewing a part of document content that the user viewed at an unusual time. In such circumstances, the fact that the time at which the user viewed the document content was unusual may indicate that the document content itself may have been more memorable for the user. For example, there may have been a specific reason for the user to view the document content at that particular time, such that the user may associate that particular time with the document content. In this manner, it may be desirable for the user to be able to benefit from indexing based, at least in part, on an impression rating that is based, at least in part, on such a user environment. In some circumstances, the user environment may indicate action by the user in relation to the apparatus. For example, the user environment may indicate that a user is likely to be reading the document content, is unlikely to be reading the document content, and/or the like. In this manner, the user environment may indicate the context of the user at the time the user viewed a particular part of the document. Therefore, the determination of the impression rating may allow for consideration of user context by way of determination of the user environment.

In at least one example embodiment, the determination of the impression rating comprises determination of a user environment during display of the part of the document content. In such an example, the determination of the impression rating for the part of the document content may be based, at least in part, on the user environment. The user environment may be based on sensor information, such as location information, proximity information, orientation information, motion information, camera module information, and/or the like. In at least one example embodiment, determination that the impression rating satisfies the impression rating threshold comprises determination that the user environment corresponds with at least one user environment exception. In at least one example embodiment, a user environment exception is a set of circumstances that, when present, indicate an exceptional user environment during display of a part of document content. For example, the user environment exception may be a set of sensor information that indicate that a user is reading the document content, such as gaze tracking information, motion information orientation information, and/or the like.

In at least one example embodiment, the user environment indicates a time of day, and the user environment exception may be an operating time exception. In such an example, the determination that the user environment corresponds with at least one user environment exception may comprise determination that the time of day deviates from a historical operational time region beyond a threshold time deviation. In at least one example embodiment, the historical operation time region identifies a time period in which a user typically operates the apparatus. In at least one example embodiment, a threshold time deviation is a time period between display of the content and the historical operation time region that is indicative of operation of the apparatus at an unusual time for the user, such as 2 hours. For example, the historical time region may indicate that the user predominantly uses the apparatus between 9:00 AM and 5:00 PM. In such an example, the apparatus may determine that the operation of the apparatus at 12:00 AM is an operating time exception.

In at least one example embodiment, the user environment indicates a time of day, and the user environment exception is a calendar entry concurrence exception. In such an example, the determination that the user environment corresponds with at least one user environment exception may comprise determination that the time of day occurs during a time of a calendar entry. In at least one example embodiment, a calendar entry concurrence exception identifies circumstances where operation of the apparatus corresponds with a calendar entry stored by the apparatus. For example, the user may be viewing document content during a meeting. In such circumstances, the user may me more likely to remember the document content by way of relating the document content to the meeting. In at least one example embodiment, the user environment further indicates a location, and the determination that the user environment corresponds with at least one user environment exception comprises determination that the location corresponds with a location of the calendar entry. In this manner, the calendar entry concurrence exception may be further based, at least in part, on concurrence between the location of the operation of the apparatus and the location of the meeting.

In at least one example embodiment, the user environment indicates location, and the user environment exception may be an operating location exception. In such an example, the determination that the user environment corresponds with at least one user environment exception may comprise determination that the location deviates from a historical location region beyond a threshold spatial deviation. In at least one example embodiment, the historical operation location region identifies geographical region in which a user typically operates the apparatus. In at least one example embodiment, a threshold spatial deviation is a distance between a location where the apparatus displayed the document content and the historical operation location region that is indicative of operation of the apparatus at an unusual location for the user, such as 3 kilometers. In at least one example embodiment, the operating location exception is based, at least in part, on identification of a location. For example, the historical location region may indicate that the user predominantly uses the apparatus between at his office. In such an example, the apparatus may determine that the operation of the apparatus at a park is an operating location exception.

In some circumstances, it may be desirable to evaluate the user environment in relation to one or more apparatuses that are proximate to the apparatus. For example, the apparatus may identify one or more apparatuses that are associated with one or more friends of the user. The identification of such apparatuses may be based, at least in part, on one or more distribution list that identifies the friends, on one or more social media accounts that identify the friends, on one or more contact entries that identify the friends, and/or the like. In at least one example embodiment, the user environment indicates at least one proximate apparatus, and the user environment exception is a proximate apparatus exception. In such an example, the determination that the user environment corresponds with at least one user environment exception comprises determination that the proximate apparatus is proximate to the apparatus. For example, determination that the proximate apparatus is proximate to the apparatus may comprise determination that a short range communication channel is available between the apparatus and the proximate apparatus, such as a Bluetooth communication channel, a near field communication channel, a wireless local area network communication channel, and/or the like. In at least one example embodiment, the user environment further indicates that the proximate apparatus is associated with a friend, and the user environment exception is a proximate apparatus exception. In such an example, the determination that the user environment corresponds with at least one user environment exception comprises determination that the proximate apparatus is associated with the friend.

In some circumstances, the user may be more likely to remember viewing document content during an extreme weather condition. For example, a user may be more likely to remember viewing document content during a tornado than viewing document content during unremarkable weather. In at least one example embodiment, the user environment indicates a weather condition, and the user environment exception is an extreme weather exception. In such an example, the determination that the user environment corresponds with at least one user environment exception comprises determination that the weather condition is an extreme weather condition. In at least one example embodiment, determination of the weather condition may be based, at least in part on one or more weather alerts, information received from a weather reporting service, and/or the like. For example, the apparatus may receive a warning of extreme weather from a public weather service.

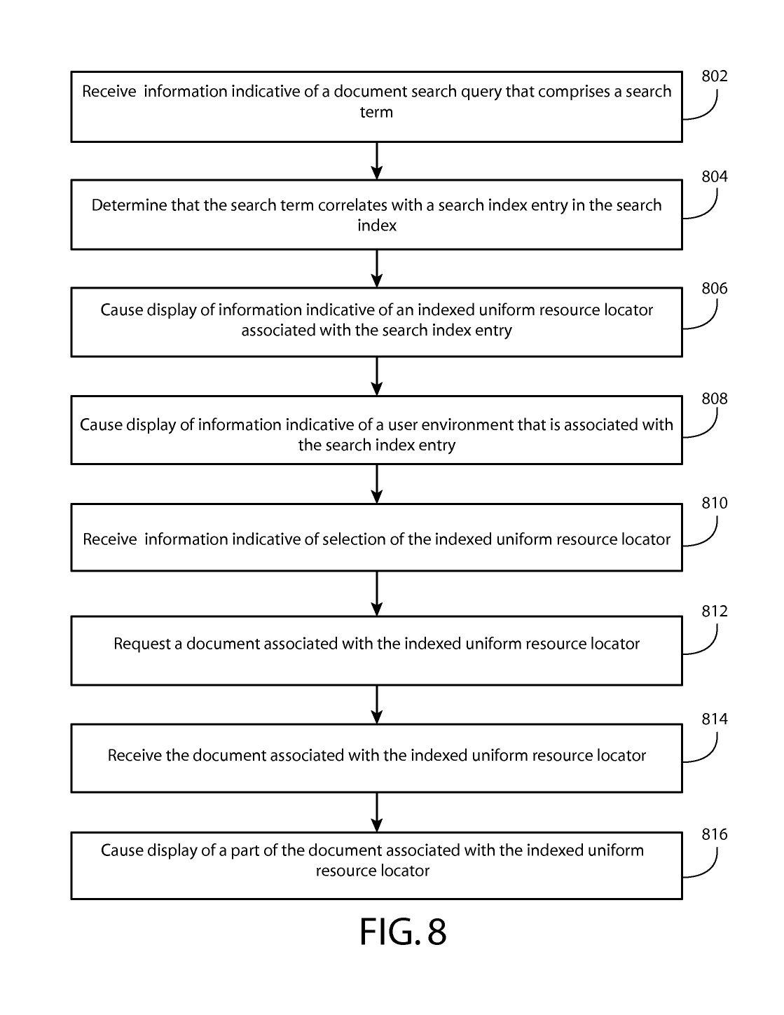

As described regarding FIG. 8, it may be beneficial for the user to be reminded of the user environment that was determined when the user viewed the document content. In this manner, it may be desirable to include user environment information in an index entry when indexing the part of the document content. In at least one example embodiment, indexing of the part of the document content comprises correlating information indicative of the user environment with the uniform resource locator. The information indicative of the user environment may be information that identifies a particular user environment, that identifies a user environment upon which an impression rating was based, and/or the like.

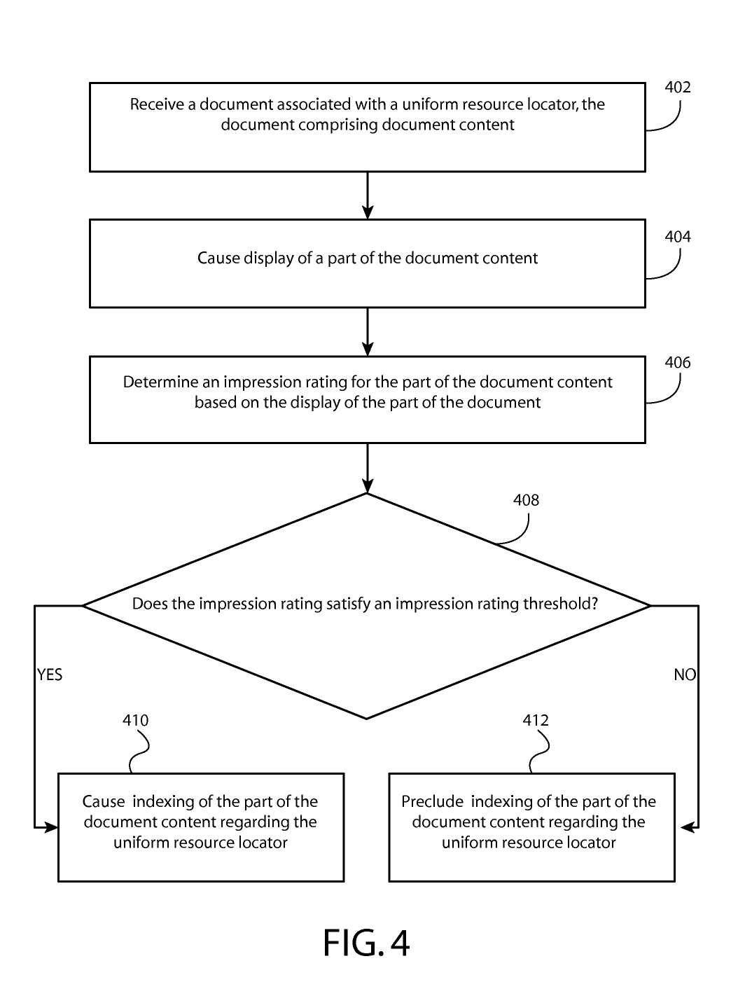

FIG. 4 is a flow diagram illustrating activities associated with indexing of part of a document according to at least one example embodiment. In at least one example embodiment, there is a set of operations that corresponds with the activities of FIG. 4. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 4.

At block 402, the apparatus receives a document identified by a uniform resource locator, the document comprising document content. The receipt, the document, the uniform resource locator, and the document content may be similar as described regarding FIG. 2 and FIGS. 3A-3C.

At block 404, the apparatus causes display of a part of the document content, the part of the document content being less than the entirety of the document content. The causation of display and the part of the document content may be similar as described regarding FIGS. 3A-3C.

At block 406, the apparatus determines an impression rating for the part of the document content based, at least in part, on the display of the part of the document. The determination and the impression rating may be similar as described regarding FIGS. 3A-3C.

At block 408, the apparatus determines whether the impression rating satisfies an impression rating threshold. The determination may be similar as described regarding FIGS. 3A-3C. If the apparatus determines that the impression rating satisfies the impression rating threshold, flow proceeds to block 41. If the apparatus determines that the impression rating fails to satisfy the impression rating threshold, flow proceeds to block 412.

At block 410, the apparatus causes indexing, into a search index, of the part of the document content with regard to the uniform resource locator. The causation of indexing, the search index, and the regard for the uniform resource locator may be similar as described regarding FIGS. 3A-3C. In this manner, the causation of indexing may be based, at least in part, on the determination that the impression rating satisfies the impression rating threshold.

At block 412, the apparatus precludes indexing, into the search index, of the part of the document content with regard to the uniform resource locator. The preclusion of indexing may be similar as described regarding FIGS. 3A-3C. In this manner, the preclusion of indexing may be based, at least in part, on the determination that the impression rating fails to satisfy the impression rating threshold.

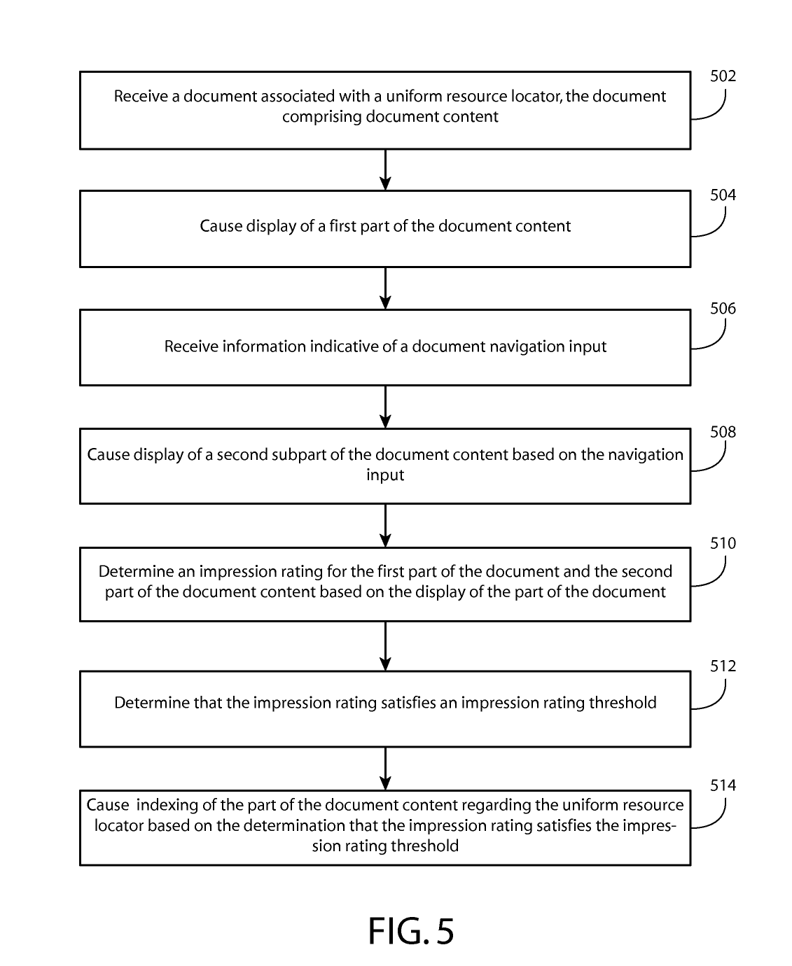

FIG. 5 is a flow diagram illustrating activities associated with indexing of part of a document according to at least one example embodiment. In at least one example embodiment, there is a set of operations that corresponds with the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

As previously described, the user may perform document navigation inputs that cause the apparatus to display different parts of the document content. In such circumstances, the impression rating may be based, at least in part, on the various parts of the document content that the user causes the apparatus to display in response to the document navigation inputs.

At block 502, the apparatus receives a document identified by a uniform resource locator, the document comprising document content, similarly as described regarding block 402 of FIG. 4. At block 504, the apparatus causes display of a first subpart of the document content. The causation of display and the first subpart of the document content may be similar as described regarding FIGS. 3A-3C.

At block 506, the apparatus receives information indicative of a document navigation input. The receipt and the document navigation input may be similar as described regarding FIGS. 3A-3C.

At block 508, the apparatus causes display of a second subpart of the document content based, at least in part, on the document navigation input. For example, the display of the second subpart of the document may be performed in conformance with the document navigation input.

At block 510, the apparatus determines an impression rating for a part of the document content based, at least in part, on the display of the part of the document, such that the part of the document content comprises the first subpart of the document content and the second subpart of the document content. The determination and the impression rating may be similar as described regarding FIGS. 3A-3C.

At block 512, the apparatus determines that the impression rating satisfies an impression rating threshold. The determination may be similar as described regarding FIGS. 3A-3C.

At block 514, the apparatus causes indexing, into a search index, of the part of the document content with regard to the uniform resource locator based, at least in part, on the determination that the impression rating satisfies the impression rating threshold. The causation of indexing, the search index, and the regard for the uniform resource locator may be similar as described regarding FIGS. 3A-3C.

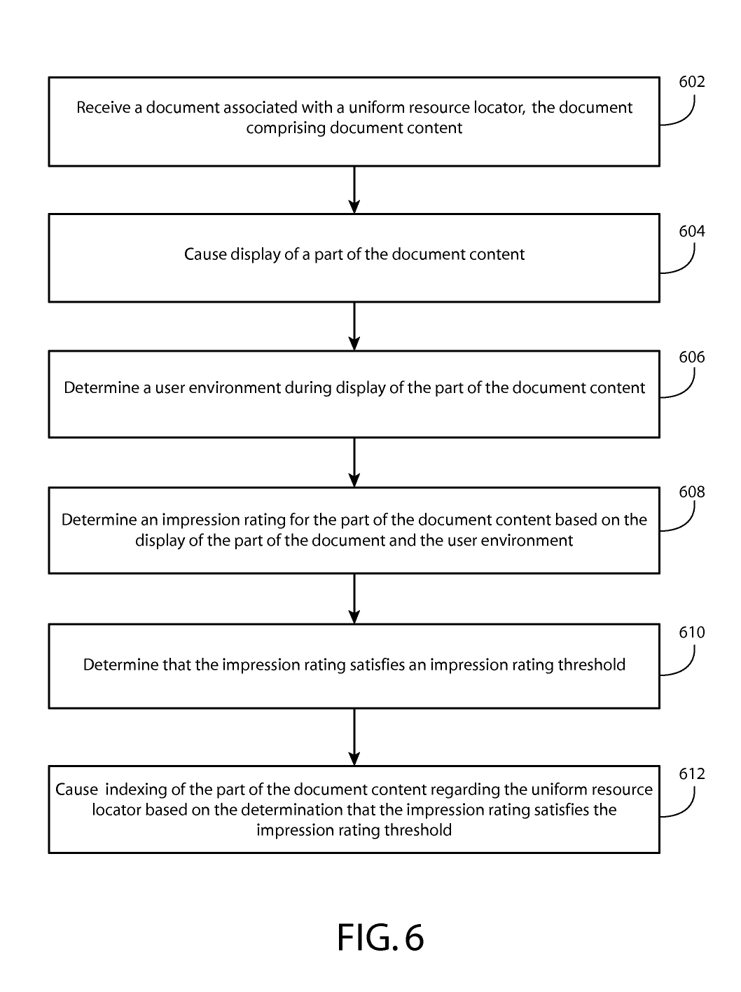

FIG. 6 is a flow diagram illustrating activities associated with indexing of part of a document according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

As previously described, in some circumstances, it may be desirable to base determination of the impression rating, at least in part, on a user environment. In this manner, the indexing of the document content may be based, at least in part, on the user environment by way of the impression rating.

At block 602, the apparatus receives a document identified by a uniform resource locator, the document comprising document content, similarly as described regarding block 402 of FIG. 4. At block 604, the apparatus causes display of a part of the document content, the part of the document content being less than the entirety of the document content, similarly as described regarding block 404 of FIG. 4.

At block 606, the apparatus determines a user environment during display of the part of the document content. The determination and the user environment may be similar as described regarding FIGS. 3A-3C.

At block 608, the apparatus determines an impression rating for the part of the document content based, at least in part, on the display of the part of the document and the user environment. The determination and the impression rating may be similar as described regarding FIGS. 3A-3C.

At block 610, the apparatus determines that the impression rating satisfies an impression rating threshold, similarly as described regarding block 512 of FIG. 5. At block 612, the apparatus causes indexing, into a search index, of the part of the document content with regard to the uniform resource locator based, at least in part, on the determination that the impression rating satisfies the impression rating threshold, similarly as described regarding block 514 of FIG. 5.

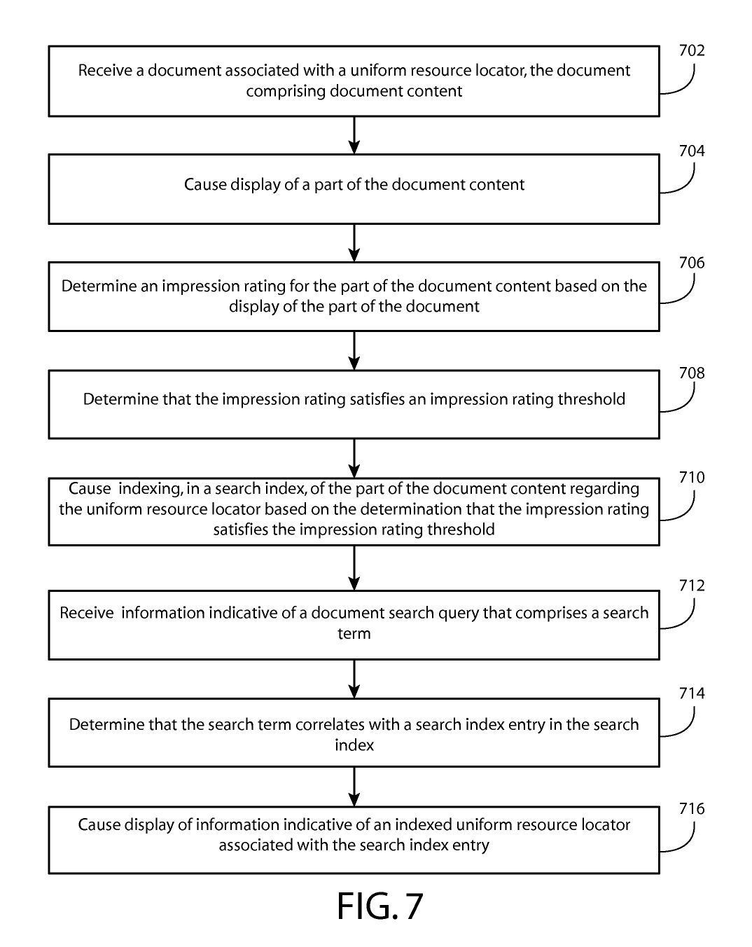

FIG. 7 is a flow diagram illustrating activities associated with indexing of part of a document according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As previously described, the apparatus may utilize the search index in response to a search query from a user. For example, subsequent to the indexing of document content to a search index, the apparatus may utilize the search index to identify an indexed uniform resource locator.

At block 702, the apparatus receives a document identified by a uniform resource locator, the document comprising document content, similarly as described regarding block 402 of FIG. 4. At block 704, the apparatus causes display of a part of the document content, the part of the document content being less than the entirety of the document content, similarly as described regarding block 404 of FIG. 4. At block 706, the apparatus determines an impression rating for the part of the document content based, at least in part, on the display of the part of the document, similarly as described regarding block 406 of FIG. 4. At block 708, the apparatus determines that the impression rating satisfies an impression rating threshold, similarly as described regarding block 512 of FIG. 5. At block 710, the apparatus causes indexing, into a search index, of the part of the document content with regard to the uniform resource locator based, at least in part, on the determination that the impression rating satisfies the impression rating threshold. The causation of indexing, the search index, and the regard for the uniform resource locator may be similar as described regarding FIGS. 3A-3C.

At block 712, the apparatus receives information indicative of a document search query that comprises at least one search term. The document search query and the search term may be similar as described regarding FIGS. 3A-3C.

At block 714, the apparatus determines that at least one of the search terms correlates with at least one search index entry in the search index. In at least one example embodiment, the determination that the search term correlates with the search index entry comprises determination that the search term matches the search index entry. For example, the search term may be identical to the search entry index, may be a different form of the search entry index, and/or the like. In at least one example embodiment, the determination that the search term correlates with the search index entry comprises determination that the search term is relevant to the search index entry. In at least one example embodiment, the determination that the search term is relevant to the search entry index refers to a determination that, even though the search term fails to match the search index entry, there exists a predetermined correlation between the search term and the search index entry. For example, the predetermined correlation may be based on a synonym relationship between the search term and the search index entry, a descriptive relationship between the search term and the search index entry, common usage of the search term with the search index entry, and/or the like. In at least one example embodiment, the predetermined correlation is based, at least in part, on a predetermined correlation list, such as a relevance table, a relevance database, and/or the like, which interrelates the search term and the search index entry. In at least one example embodiment, the determination of relevance between a search term and a search index entry is independent of the impression rating of a part of document content.

At block 716, the apparatus causes display of information indicative of an indexed uniform resource locator associated with the search index entry. The information indicative of the uniform resource locator may be information that is configured to identify the uniform resource locator, a document referenced by the uniform resource locator, and/or the like. In at least one example embodiment, the information indicative of the indexed uniform resource locator comprises document content of a document identified by the indexed uniform resource locator. For example, the information indicative of the uniform resource locator may be document content that was stored as part of the search index entry, such as document content that was part of the basis for the impression rating determination. For example, regarding FIG. 3A, if image content 306 was part of the basis for determination of an impression rating that caused indexing of document 300, image content 306 may be information indicative of a uniform resource locator associated with document 300.

As previously described, the user may desire to avoid utilization of an external search engine. However, in some circumstances, the user may desire to condition utilization of an external search engine upon failure to determine that the search term correlates with a search index entry. For example, if the apparatus fails to determine that the search term correlates with the search index entry at block 714, the apparatus may send a search query to the external search engine.

FIG. 8 is a flow diagram illustrating activities associated with utilization of a search index according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As previously described, the user may be able to remember viewing document content in relation to the user environment at the time the apparatus displayed the document content. In this manner, it may be desirable to cause display of information indicative of the user environment in conjunction with information indicative of the uniform resource locator. For example, the user may be able to more easily remember a webpage that the user viewed during a tornado if the apparatus informs the user that the webpage was viewed during the tornado. In this manner, the information indicative of the user environment may help the user remember the document content by way of reminding the user of the user environment during display of the document content. In some circumstances, the apparatus may be configured to allow a user to transition to viewing a document referenced by a uniform resource locator subsequent to display of the information indicative of the uniform resource locator.

At block 802, the apparatus receives information indicative of a document search query that comprises at least one search term, similarly as described regarding block 712 of FIG. 7. At block 804, the apparatus determines that at least one of the search terms correlates with at least one search index entry in the search index, similarly as described regarding block 714 of FIG. 7. At block 806, the apparatus causes display of information indicative of an indexed uniform resource locator associated with the search index entry, similarly as described regarding block 718 of FIG. 7.

As previously described, in at least one example embodiment, the search index entry comprises information indicative of a user environment. For example, the information indicative of the user environment may have been included in the search index entry to indicate a user environment associated with a prior display of a part of an associated document. At block 808, the apparatus causes display of information indicative of the user environment in relation to the information indicative of the indexed uniform resource locator.

At block 810, the apparatus receives information indicative of selection of the indexed uniform resource locator. The selection may be an input that has apposition that corresponds with a position of display of the information indicative of the uniform resource locator, an input that identifies the uniform resource locator, and/or the like.

At block 812, the apparatus requests, at least a portion of, a document identified by the indexed uniform resource locator. The request, the document, and the association may be similar as described regarding FIG. 2.

At block 814, the apparatus receives the document identified by the indexed uniform resource locator. The receipt may be similar as described regarding FIG. 2.

At block 816, the apparatus causes display of the document identified by the indexed uniform resource locator. The causation of display may be similar as described regarding FIG. 2 and FIGS. 3A-3C.

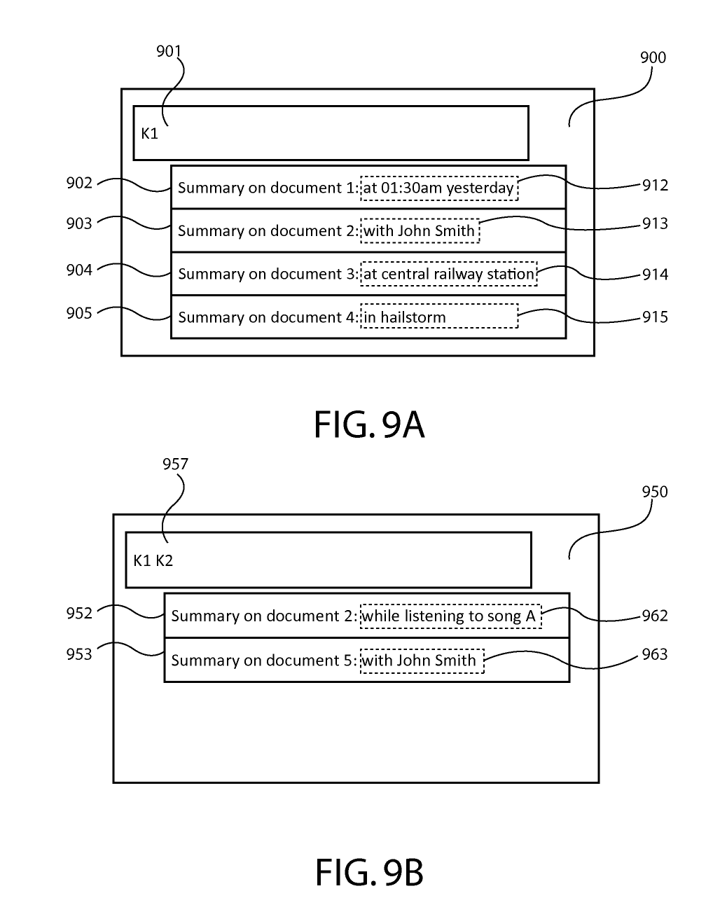

FIGS. 9A-9B are diagrams illustrating display of information indicative of the user environment in conjunction with information indicative of the uniform resource locator according to at least one example embodiment. The examples of FIGS. 9A-9B are merely examples and do not limit the scope of the claims. For example, information indicative of the uniform resource locator may vary, representation of information may vary, amount of information displayed may vary, and/or the like.

The example of FIG. 9A illustrates a user interface 900 that an apparatus provides for providing a response to a search query from a user. Block 901 is a dialog box that allows a user to enter one or more search terms. It can be seen that, in block 901, a user has entered a search term of “K1.” It can be seen that the apparatus has provided information 902-905 that is indicative of a uniform resource locator associated with the search term. In the example of FIG. 9A, the information indicative of the uniform resource locator is a summary of a document referenced by the uniform resource locator. In at least one example embodiment, the summary of the document may be information comprised by the search index regarding the particular document. For example, the summary may indicate one or more parts of the document that have a particular impression rating, one or more parts of the document that have an impression rating above an impression rating threshold, and/or the like.

In the example of FIG. 9A, the apparatus causes display of information 912-915, which is indicative of user environments associated with the documents of information 902-905, respectively. It can be seen that information 912 is displayed proximate to information 902. In this manner, the proximity of information 912 to information 902 allows a user to identify the relatedness between the user environment and the information indicative of the uniform resource locator. Similarly, information 913 is displayed proximate to information 903, information 914 is displayed proximate to information 904, and information 915 is displayed proximate to information 905.

In the example of FIG. 9A, each search result may be provided based, at least in part, on correlation between the search term and a search index entry that corresponds with the search term. For example, each of the search results of FIG. 9A may be listed based, at least in part, on correlation between the search term and search index entries. In at least one example embodiment, the search results are ordered in accordance with relevance of the search term with respect to the search index entry. For example, the apparatus may order more relevant search results above less relevant search results.

In the example of FIG. 9A, each search result indicates a different user environment associated with the viewing of the respective documents. For example, information 912 indicates that the document was viewed the previous day at 1:30 AM, which may be an unusual time for the user to be utilizing the apparatus. Information 913 indicates that the document was viewed while the user was with John smith. Information 914 indicates that the document was viewed while the user was at central railway station. Information 915 indicates that the document was viewed during a hailstorm.

User interface 900 may dynamically populate the list of search results as the user types search terms, may provide the list of search results upon the user completing typing of the search term, and/or the like. For example, the apparatus may provide the information 902-905 and information 912-915 as the user is typing “K1,” after the user has typed “K1,” and/or the like.

The example of FIG. 9B illustrates a user interface 950 that an apparatus provides for providing a response to a search query from a user. It can be seen that user interface 950 represents user interface 900 at a later time, where the user has continued typing in block 951 to prove an additional search term of K2.” It can be seen that the apparatus has provided information 952 and 953 that is indicative of a uniform resource locator associated with the search term. In the example of FIG. 9B, the apparatus causes display of information 962 and 963, which is indicative of user environments associated with the documents of information 952 and 953, respectively. In the example of FIG. 9A, each search result indicates a different user environment associated with the viewing of the respective documents. For example, information 962 indicates that the document was viewed while listening to song A and information 963 indicates that the document was viewed while the user was with John smith.

In the example of FIG. 9B, there are fewer search results provided, by the apparatus. In this manner, the addition of the search term “K2” to the search term “K1” may have caused the apparatus to identify fewer corresponding search index entries. It can be seen that, even though document 2 is represented by information 903 and information 952, that the information that represents document 2 may vary. For example, the search index entry associated with “K1” may indicate different summary information, may indicate different impression ratings, and/or the like. Similarly, it can be seen in the example of FIG. 9B that the user environment indicated by information 962 is different from the user environment indicated by information 913, even though both information 913 and information 962 are associated with document 2. In this manner, the apparatus may provide information indicative of the user environment based, at least in part, on the search term. For example, the user may have viewed a part of document 2 that relates to “K1” while with John Smith, but may have failed to view a part of document 2 that relates to “K2” while with John Smith. However, the user may have, at a different time, viewed the parts of document 2 that relate to “K1” and “K2” while listening to song A. In this manner, the apparatus may select the user environment information indicative of listening to song A based, at least in part, on better correlation between the user environment and the search terms. In this manner, the apparatus may better remind the user of the user environment during viewing of the document because the user environment information provided correlates more closely with the user environment associated with viewing of the particular parts of the document that correspond with the search terms.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 404 of FIG. 4 may be performed after block 406 of FIG. 4. Furthermore, if desired, one or more of the above-described functions may be optional or may be combined. For example, blocks 504, 506, and 508 of FIG. 5 may be optional and/or combined with block 404 of FIG. 4.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. A method comprising:
receiving a document identified by a uniform resource locator, the document comprising document content;
causing display of a part of the document content, the part of the document content being less than the entirety of the document content;
determining an impression rating for the part of the document content based, at least in part, on the display of the part of the document;
determining that the impression rating satisfies an impression rating threshold; and
causing indexing, into a search index, of the part of the document content with regard to the uniform resource locator based, at least in part, on the determination that the impression rating satisfies the impression rating threshold.

2. The method of claim 1, wherein determining the impression rating comprises determination of a display duration of the part of the document, and determining the impression rating for the part of the document content is based, at least in part, on the display duration.

3. The method of claim 1, further comprising receipt of information indicative of at least one document navigation input, wherein determining the impression rating comprises determination of an amount of navigation performed during display of the part of the document content, and determining the impression rating for the part of the document content is based, at least in part, on the amount of navigation.

4. The method of claim 1, wherein causing display of the part of the document comprises:
causing display of a first subpart of the document content;
receiving information indicative of a document navigation input; and
causing display of a second subpart of the document content based, at least in part, on the document navigation input, wherein the part of the document content comprises the first subpart of the document content and the second subpart of the document content.

5. The method of claim 1, wherein determining the impression rating comprises determination of a prominence rating of the part of the document, and determining the impression rating for the part of the document content is based, at least in part, on the prominence rating.

6. The method of claim 5, wherein the prominence rating is a quantification that indicates a measure of visual emphasis of a part of the document content with respect to another part of the document content.

7. The method of claim 1, wherein determining the impression rating comprises determination of a user environment during display of the part of the document content, and determining the impression rating for the part of the document content is based, at least in part, on the user environment.

8. The method of claim 1, further comprising:
receiving information indicative of a document search query that comprises at least one search term;
determining that at least one of the search terms correlates with at least one search index entry in the search index, the search index entry comprising information indicative of a user environment; and
causing display of information indicative of an indexed uniform resource locator associated with the search index entry,
causing display of information indicative of the user environment in relation to the information indicative of the indexed uniform resource locator.

9. The method of claim 1, further comprising:
causing display of a different part of the document content;
determining a different impression rating for the different part of the document content based, at least in part, on the display of the different part of the document;
determining whether the different impression rating satisfies the impression rating threshold; and
precluding indexing, into the search index, of the different part of the document content with regard to the uniform resource locator based, at least in part, on determination that the different impression rating fails to satisfy the impression rating threshold.

10. An apparatus comprising:
at least one processor or a portion of a processor and at least one memory including computer program code, that when executed by the processor, cause the apparatus to:
receive a document identified by a uniform resource locator, the document comprising document content;
cause display of a part of the document content, the part of the document content being less than the entirety of the document content;
determine an impression rating for the part of the document content based, at least in part, on the display of the part of the document;
determine that the impression rating satisfies an impression rating threshold; and
cause indexing, into a search index, of the part of the document content with regard to the uniform resource locator based, at least in part, on the determination that the impression rating satisfies the impression rating threshold.

11. The apparatus of claim 10, wherein the impression rating is a quantification of criteria that indicates significance of the part of the document content to a user in relation to the display of the part of the document content.

12. The apparatus of claim 10, wherein the determination of the impression rating comprises determination of a display duration of the part of the document, and the determination of the impression rating for the part of the document content is based, at least in part, on the display duration.

13. The apparatus of claim 10, further comprising receipt of information indicative of at least one document navigation input, wherein the determination of the impression rating comprises determination of an amount of navigation performed during display of the part of the document content, and the determination of the impression rating for the part of the document content is based, at least in part, on the amount of navigation.

14. The apparatus of claim 10, wherein causing display of the part of the document comprises:
causing display of a first subpart of the document content;
receiving information indicative of a document navigation input; and
causing display of a second subpart of the document content based, at least in part, on the document navigation input, wherein the part of the document content comprises the first subpart of the document content and the second subpart of the document content.

15. The apparatus of claim 10, wherein the determination of the impression rating comprises determination of a prominence rating of the part of the document, and the determination the impression rating for the part of the document content is based, at least in part, on the prominence rating.

16. The apparatus of claim 15, wherein the prominence rating is a quantification that indicates a measure of visual emphasis of a part of the document content with respect to another part of the document content.

17. The apparatus of claim 10, wherein the determination of the impression rating comprises determination of a user environment during display of the part of the document content, and the determination of the impression rating for the part of the document content is based, at least in part, on the user environment.

18. The apparatus of claim 10, wherein the computer program code, when executed by the processor, further causes the apparatus to:
receive information indicative of a document search query that comprises at least one search term;
determine that at least one of the search terms correlates with at least one search index entry in the search index, the search index entry comprising information indicative of a user environment; and
cause display of information indicative of an indexed uniform resource locator associated with the search index entry;
, cause display of information indicative of the user environment in relation to the information indicative of the indexed uniform resource locator.

19. The apparatus of claim 10, wherein the computer program code, when executed by the processor, further causes the apparatus to:
cause display of a different part of the document content;
determine a different impression rating for the different part of the document content based, at least in part, on the display of the different part of the document;
determine whether the different impression rating satisfies the impression rating threshold; and
preclude indexing, into the search index, of the different part of the document content with regard to the uniform resource locator based, at least in part, on determination that the different impression rating fails to satisfy the impression rating threshold.

20. A tangible non-transitory computer readable medium with computer program code stored thereon, the computer program code, when executed by a processor, cause an apparatus to:
receive a document identified by a uniform resource locator, the document comprising document content;
cause display of a part of the document content, the part of the document content being less than the entirety of the document content;
determine an impression rating for the part of the document content based, at least in part, on the display of the part of the document;
determine that the impression rating satisfies an impression rating threshold; and
cause indexing, into a search index, of the part of the document content with regard to the uniform resource locator based, at least in part, on the determination that the impression rating satisfies the impression rating threshold.
